(19) United States
(12) Patent Application Publication
(10) Pub. No.: US 2026/0048668 A1
(43) Pub. Date: Feb. 19, 2026

(54) METHOD FOR OPERATING A DRIVING DEVICE OF A WORKING MACHINE

(71) Applicant: ZF Friedrichshafen AG, Friedrichshafen (DE)

(72) Inventors: Matthias DULLER, Friedrichshafen (DE); Simon GEIGER, Oberteuringen (DE)

(73) Assignee: ZF Friedrichshafen AG, Friedrichshafen (DE)

(21) Appl. No.: 19/297,192

(22) Filed: Aug. 12, 2025

(30) Foreign Application Priority Data
Aug. 13, 2024 (DE) 10 2024 207 693.7

(51) Int. Cl. B60L 15/10; B60L 3/12; B60L 15/20

(52) U.S. Cl. CPC B60L 15/10; B60L 3/12; B60L 15/20; B60L 2200/40; B60L 2240/421; B60L 2240/423; B60L 2250/28

(57) ABSTRACT

A method is provided for operating a drive device (1) for a working machine (100). The drive device (1) has a motor (2) and a power-branched transmission (3) with a variator (5) for the continuously variable adjustment of a gear ratio of the transmission (3). The method includes determining a nominal motor rotation speed (n), receiving a current motor load (L) of the motor (2), and determining an accelerator pedal position (P) on the basis of the nominal motor rotation speed (n) determined and the motor load (L) received. In addition, the method includes transmitting the accelerator pedal position (P) determined to the motor (2).

### RELATED APPLICATIONS

This application claims the benefit of and right of priority under 35 U.S.C. § 119 to German Patent Application no. 10 2024 207 693.7, filed on 13 Aug. 2024, the contents of which are incorporated herein by reference in its entirety.

### TECHNICAL FIELD

The present invention relates to a method for operating a drive device of a working machine. In addition, the present invention relates to a control unit designed to carry out such a method, to a drive device with such a control unit, and to a working machine with such a drive device.

### BACKGROUND

In the sector of working machines, drive devices with a motor and a power-branched transmission are used. Such power-branched transmissions can comprise a variator with which a gear ratio of the transmission can be adjusted in a continuously variable manner. The motors of such drive devices can provide various control options, for example control by way of an accelerator pedal position and alternatively or in addition control by virtue of a nominal motor rotation speed. For the various control options, various types of motor rotation speed regulation systems can be incorporated in the motor.

### SUMMARY

The present invention relates to a method for operating a drive device for a working machine. The working machine can be a building, agricultural or forestry machine. For example, the working machine is a wheel loader. The drive device comprises a motor and a power-branched transmission. The motor can be an internal combustion engine, and alternatively or in addition, an electric motor. The power-branched transmission can be a hydrostatic-mechanical transmission, and alternatively or in addition, an electro-mechanical power-branched transmission. The power-branched transmission can comprise a mechanical power branch and a hydrostatic power branch, and alternatively or in addition, an electrical power branch. The power-branched transmission comprises a variator in order to be able to adjust a gear ratio of the transmission in a continuously variable manner. For example, the power-branched transmission can be designed such that by way of a mechanical power branch various fixed gear ratios can be engaged between a drive input and a drive output of the transmission. The various gear ratios can include driving ranges of the working machine. Within these driving ranges, the gear ratio can be adjusted on a continuously variable basis by means of the variator. The variator can be in the form of a hydrostat and can comprise two hydraulic machines which can be in hydrodynamic functional connection with one another. Alternatively, or in addition, the variator can also comprise two electric machines which can be in electrical functional connection with one another.

The method involves determining a nominal motor rotation speed. The nominal motor rotation speed can be a motor rotation speed to which the motor should be adjusted. The nominal motor rotation speed can be determined on the basis of various condition parameters of the drive device and, alternatively or in addition, of a driving strategy of the drive device. The nominal motor rotation speed can be determined in such manner that the drive device can be operated as efficiently as possible, and alternatively or in addition, with a particularly high power output. The nominal motor rotation speed can be determined by a control unit which is provided functionally, and alternatively or in addition, positionally separate from the motor. Besides determining the nominal motor rotation speed, the control unit can also have further functions in the drive device. Alternatively, the nominal motor rotation speed can also be determined by a control unit which is functionally, and alternatively or in addition, positionally associated with the motor of the drive device. The nominal motor rotation speed can be in a range between 0 rpm and 3000 rpm, such as between 0 rpm and 2500 rpm, and in an embodiment between 500 rpm and 2500 rpm.

Furthermore, the method includes the detection of a current motor load. At a particular rotation speed the motor load can be proportional to the motor torque supplied and accordingly describes a workload of the motor. For example, the motor load can be expressed as a percentage value, namely, what percentage of the maximum power that can be obtained at the rotation speed concerned is actually available. Thus, the motor load determined can range from 0% to 100%. The motor load of the motor can depend on the current driving situation of the working machine, for example the resistances opposing the action of the working machine. The current motor load can be determined as a direct parameter. Alternatively, or in addition, one or more parameters can be detected, which are in a fixed relationship with the motor load.

In addition, the method includes a determination of an accelerator pedal position on the basis of the motor rotation speed determined and the motor load determined. During this step, on the basis of the motor rotation speed determined and the current motor load, an accelerator pedal position can be determined, which when communicated to the motor, results in a motor rotation speed that corresponds to the nominal motor rotation speed. The accelerator pedal position can range between values of 0% and 100%, and can correspond to a percentage of a full accelerator pedal depression. Furthermore, the method includes communicating the particular accelerator pedal position to the motor. On the basis of the particular accelerator pedal position communicated, the motor can now adjust a motor rotation speed. Thus, as described above, in this method the accelerator pedal position can be determined so that that the motor rotation speed obtained corresponds to the nominal motor rotation speed.

By virtue of the present method, an existing actuation option in a motor can be used by way of an accelerator pedal position even though a nominal motor rotation speed should be set. Thus, for example, despite an intended motor rotation speed control the regulation logic provided by the motor can be used with the accelerator pedal actuation. This is an advantage when the regulation logic provided by virtue of the accelerator pedal actuation is beneficial for a drive device with a power-branched transmission comprising a variator, As a result, with the method of the present invention, an optimized control logic can be used in the case of a power-branched transmission comprising a variator. Thus, for example, with a power-branched transmission having a variator, it is advantageous to use a motor rotation speed regulation system that comprises a proportional regulator. Only in that way can stable motor rotation speed control be provided that is suitable for a power-branched transmission with a variator. A proportional regulator can be understood to mean a regulator with a proportional component. Besides that, the regulator can also comprise an integral component, and alternatively or in addition, a differential component. In an embodiment, the proportional regulator is a purely proportional regulator which does not comprise an integral component or a differential component. For example, if the motor enables proportional regulation only by virtue of accelerator pedal actuation, then the motor can be designed to use the proportional regulator even though motor rotation speed control is actually intended.

In an embodiment, the determination of the current motor load entails determining the motor load from a motor control unit of the motor. For example, the motor can send the current motor load via its motor control unit by way of a signal transmission device such as a CAN bus. The current motor load can be sent to the CAN bus by the motor control unit, for example continually, and alternatively or in addition, at certain time-points. In such case, the motor control unit can be a control unit associated with the motor, both functionally and positionally. The motor control unit can be tasked with regulating the motor torque and, alternatively or in addition, the motor rotation speed.

In an embodiment, the determination of the nominal motor rotation speed involves determining the nominal motor rotation speed by means of a transmission control unit of the drive device. For example, the nominal motor rotation speed can be determined by the transmission control unit in such manner that the drive device, for example the transmission, can be operated as efficiently as possible and, alternatively or in addition, with the maximum possible power. Besides, the transmission control unit of the drive device can also have the function of controlling the transmission, for example the gear ratio of the transmission, as a function of the driving situation. The transmission control unit can be provided both functionally and positionally separate from the motor control unit. The transmission control unit can comprise a motor interface by way of which it can communicate with the motor control unit, for example via the aforesaid CAN bus. Thus, for example, by way of the CAN bus, the transmission control unit can receive from the motor control unit the load currently imposed on the motor. By way of the motor interface and the CAN bus, the transmission control unit can also communicate the specific accelerator pedal position to the motor control unit.

In an embodiment, the accelerator pedal position is determined on the basis of a data set. The data set can be stored in the form of a look-up table or in some other way, for example in the transmission control unit. The data set can associate a number of value pairs consisting of a nominal motor rotation speed and a motor load with an accelerator pedal position. Thus, if the nominal motor rotation speed and the current motor load are known, from the data set an accelerator pedal position associated with them can be determined. The data set can be designed in a motor-specific manner. For example, the data set is designed with a view to the normal operation of the drive device, which in an embodiment can be done by virtue of various measurement series carried out on a measurement bench, and alternatively or in addition, by means of a simulation. The data set can be designed such that it associates a value pair consisting of a nominal motor rotation speed and a current motor load with a specific accelerator pedal position. The data set can also be designed such that when the particular accelerator pedal position is transmitted to the motor, the motor is adjusted to the nominal motor rotation speed. By the provision of such a data set, the accelerator pedal position required for setting a particular nominal motor rotation speed can be determined in a simple manner.

In an embodiment, the determination of the accelerator pedal position involves restricting the accelerator pedal position to an accelerator pedal position that corresponds with a maximum permitted rotation speed of the motor. For example, if the motor should not be operated above a permitted maximum rotation speed, then in this embodiment only such accelerator pedal positions are determined which when transmitted to the motor result in motor rotation speeds which are lower than the maximum rotation speed. For example, if the nominal motor rotation speed determined is higher than the maximum permitted rotation speed, then the nominal motor rotation speed can be limited to the permitted maximum rotation speed. An accelerator pedal position is then determined, such that it corresponds with the permitted maximum motor rotation speed and the current load on the motor. By virtue of this embodiment, it can be ensured that even if the motor is controlled only in accordance with the accelerator pedal position, the motor will not rotate at a speed higher than the permitted maximum rotation speed.

In addition, the present invention relates to a control unit which is intended, i.e., specifically designed, for example programmed, to carry out a method according to one of the above-described embodiments. The control unit can have one or more interfaces for communicating with the respective components of the drive device, these interfaces each being able to be input interfaces and/or output interfaces. The control unit can be a transmission control unit in accordance with the above embodiments. Regarding the designs and advantages of the individual features, reference should be made to the above descriptions in connection with the method for operating the working machine.

Furthermore, the present invention relates to a drive device with a motor and a power-branched transmission comprising a variator for the continuously variable adjustment of a gear ratio of the transmission. The drive device also comprises a control unit according to the embodiment described earlier, which, as described above, can be in the form of a transmission control unit. The drive device can further comprise a motor control unit for receiving the accelerator pedal position, for example from the transmission control unit. The motor control unit can be designed such that, on the basis of the accelerator pedal position received, it adjusts the motor rotation speed by way of a proportional regulator. Furthermore, the motor control unit can be designed to adjust the motor rotation speed of the motor on the basis of a received nominal motor rotation speed and by means of a regulator other than a proportional regulator. In other words, in this embodiment the motor can be adjusted with a proportional regulator by way of the accelerator pedal position alone. Moreover, the present invention relates to a working machine with such a drive device. Regarding the designs and advantages of the individual features, reference should be made to the above descriptions in connection with the method for operating the working machine.

### BRIEF DESCRIPTION OF THE FIGURES

FIG. 1 shows a schematic representation of a working machine according to an embodiment.

FIG. 2 shows a schematic representation of a drive device of the working machine in FIG. 1.

FIG. 3 shows, schematically, a flow chart of a method for operating the drive device of FIG. 2, according to an embodiment.

FIG. 4 illustrates a data set of the drive device of FIG. 2, for determining an accelerator pedal position in accordance with an embodiment.

### DETAILED DESCRIPTION OF EMBODIMENTS

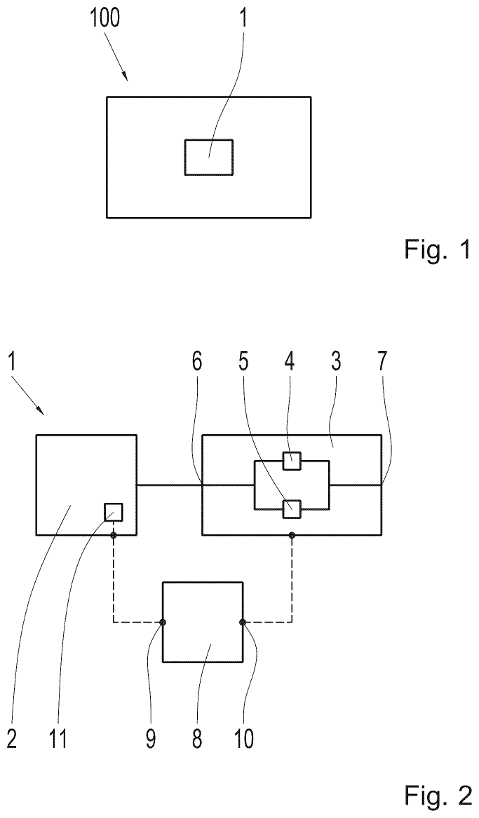

FIG. 1 shows a working machine 100 with a drive device 1, according to an embodiment of the present invention. The working machine 100 comprises a plurality of wheels (not shown), which can be driven by the drive device 1. The drive device 1 comprises a motor 2, which in this embodiment is in the form of an internal combustion engine. In addition, the drive device 1 comprises a power-branched transmission 3 with a mechanical power path 4 and a hydraulic power path with a variator 5. The power-branched transmission 3 has a drive input 6 and a drive output 7. The drive input 6 is functionally connected to the motor 2. The drive output 7 of the power-branched transmission 3 is mechanically functionally connected to the wheels (not shown) of the working machine 100. In this case the drive output rotation speed of the drive device 1 is in a fixed, defined relationship relative to the rotation speed of the wheels and thus to the driving speed of the working machine.

By way of the mechanical power path 4 of the power-branched transmission 3, which in this embodiment comprises a plurality of shifting elements (not shown), various fixed gear ratios, and thus various driving ranges, can be engaged between the drive input 6 and the drive output 7 of the transmission 3. Within the driving ranges the gear ratio can be adjusted continuously variably by the variator 5. In this embodiment, the variator 5 is in the form of a hydrostat with two hydraulic machines which are in hydraulic functional connection with one another. By adjusting the stroke volume of the variator 5, the transmission ratio of the hydraulic power branch, and hence also the gear ratio of the transmission 3, can be adjusted continuously. Furthermore, the drive device I comprises a control unit 8 for controlling the drive device 1, which in the present case is in the form of a transmission control unit. The control unit 8 comprises a motor interface 9 for controlling the motor 2. In addition, the control unit 8 comprises a transmission interface 10 for controlling the power-branched transmission 3, among other things for engaging the driving range of the mechanical power branch 4 and for adjusting the variator 5 of the hydraulic power branch.

In addition, the drive device 1 comprises a motor control unit 11 with an input interface for receiving a control parameter from the transmission control unit 8. The input interface of the motor control unit 11 is electronically connected with the motor interface 9 of the transmission control unit 8 by way of a CAN bus. The motor control unit 11 is designed to regulate the motor rotation speed of the motor 2 on the basis of the control parameter sent to the input interface via the CAN bus. In this embodiment the motor control unit 11 is designed such that via the CAN bus it can specify a nominal motor rotation speed n. On the basis of this nominal motor rotation speed n received via the input interface, the motor control unit 11 adjusts the motor rotation speed of the motor 2. This adjustment takes place on the basis of a regulator which is not a proportional regulator. Furthermore, the motor control unit 11 is designed to receive an accelerator pedal position P as a control parameter from the transmission control unit 8 via the input interface. On the basis of the accelerator pedal position P received, the motor control unit 11 then regulates the motor rotation speed of the motor 2. In this case the regulation takes place on the basis of a proportional regulator, i.e., a regulator which least also comprises a proportional component. In this embodiment the regulator is purely proportional, comprising only a proportional component but no integral or differential component. The motor control unit 11 is also designed to transmit the motor load L currently imposed on the motor 2 by way of the CAN bus.

In the transmission control unit 8 a data set is stored, which associates various value pairs consisting of a nominal motor rotation speed n and a motor load L with an accelerator pedal position P in each case. This data set is illustrated schematically in FIG. 4. In the present embodiment the data set stored in the transmission control unit 8 associates nominal motor rotation speeds n between 800 rpm and around 2100 rpm and motor loads between 0% and 100% with an accelerator pedal position P between 0% and 100%. If the nominal motor rotation speed n and the load L currently imposed on the motor 2 are known, then on the basis of the data set shown in FIG. 4 an accelerator pedal position P can be determined from the data set without ambiguity. The data set shown in FIG. 4 is specifically created for the motor 2 of the drive device 1. For a particular nominal motor rotation speed n to be reached by the motor 2, then by way of the input interface the pedal position deduced from FIG. 4, which in turn depends on the current motor load L, is transmitted via the motor interface 9 and the CAN bus to the motor control unit 11. In this case, the data set is designed such that as the nominal motor rotation speed n and the motor load L increase, the accelerator pedal position increases.

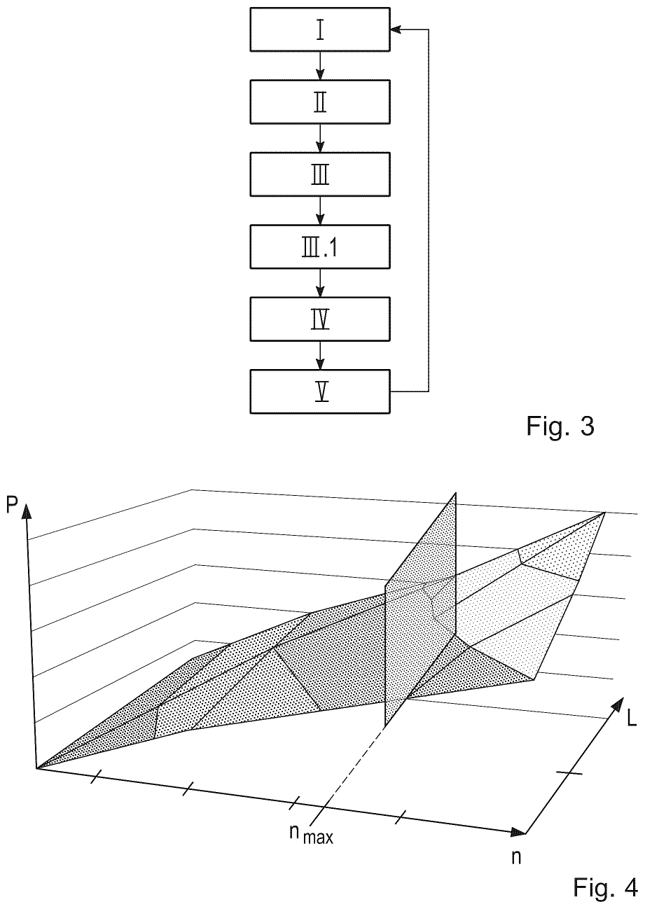

The transmission control unit 8 is designed to carry out the method described below with reference to FIG. 3. In a first step I, the transmission control unit 8 determines a nominal motor rotation speed n. In the present embodiment this takes place on the basis of a driving strategy of the working machine 100 stored in the transmission control unit 8, which specifies a nominal motor rotation speed n for the motor 2 on the basis of various condition parameters of the drive device 1. In a following step II, the transmission control unit 8 now receives the current load L on the motor 2 from the motor control unit 11 via the motor interface 9 and the CAN bus. In this embodiment the current load L imposed on the motor 2 is sent continuously by the motor control unit 11 to the CAN bus and can therefore be received by the transmission control unit 8 by way of the motor interface 9 in real time.

On the basis of the nominal motor rotation speed n determined and the motor load L received, in a following step III the transmission control unit 8 now determines an accelerator pedal position P. For that purpose, use is made of the data set stored in the transmission control unit 8 and illustrated in FIG. 4, which associates a specific accelerator pedal position with the value pairs consisting of the nominal motor rotation speed n and the motor load L. The determination III of the accelerator pedal position P also includes a check III.1 of whether the nominal motor rotation speed n determined in step I is higher than a permitted maximum rotation speed nₘₐₓ of the motor 2. If that is the case, then in step III.1 the nominal motor rotation speed n is restricted to the maximum permissible rotation speed nₘₐₓ. As the accelerator pedal position P, in this step III.1 that accelerator pedal position P is then deduced from the data set which corresponds with the permitted maximum rotation speed nₘₐₓ and the motor load L currently imposed on the motor 2. This ensures that the motor 2 does not rotate at a rotation speed higher than its permitted maximum rotation speed nₘₐₓ.

In a following step IV, the transmission control unit 8 transmits the accelerator pedal position P determined in steps III and III.1 to the motor control unit 11 via the motor interface 9 and the CAN bus. The motor control unit 11 receives the accelerator pedal position P via the input interface and in a following step V regulates the rotation speed of the motor 2 to the received accelerator pedal position P. After that the method reverts back to step I.

### INDEXES

1 Drive device
2 Motor
3 Power-branched transmission
4 Mechanical power branch
5 Variator
6 Drive input
7 Drive output
8 Transmission control unit
9 Motor interface
10 Transmission interface
11 Motor control unit
I Determination of the motor rotation speed
II Detection of the motor load
III Determination of the accelerator pedal position
III.1 Restriction of the accelerator pedal position
IV Transmission of the accelerator pedal position
V Regulation of the motor rotation speed
P Accelerator pedal position
L Current motor load
n Nominal motor rotation speed
nₘₐₓ Permitted maximum rotation speed

1. A method for operating a drive device (1) for a working machine (100), wherein the drive device (1) comprises a motor (2) and a power-branched transmission (3) with a variator (5) for the continuously variable adjustment of a gear ratio of the transmission (3), the method comprising:
determining a nominal motor rotation speed (n);
receiving a current motor load (L) of the motor (2);
determining an accelerator pedal position (P) on the basis of the nominal motor rotation speed (n) determined and the motor load (L) received; and
sending the accelerator pedal position (P) to the motor (2).

2. The method according to claim 1, wherein receiving the current motor load (L) of the motor (2) includes receiving the motor load (L) from a motor control unit (11) of the motor (2) of the drive device (1).

3. The method according to claim 1, wherein determining the nominal motor rotation speed (n) includes determining the nominal motor rotation speed (n) by a transmission control unit (8) of the drive device (1).

4. The method according to claim 1, wherein determining the accelerator pedal position (P) takes place on the basis of a data set, which associates a respective acceleration pedal position (P) with one of a number of value pairs, each consisting of a nominal motor rotation speed (n) and a motor load (L).

5. The method according to claims claim 1, wherein determining the accelerator pedal position (P) includes restricting (III.1) the accelerator pedal position (P) to an accelerator pedal position (P) that corresponds to a permissible maximum rotation speed (nₘₐₓ) of the motor (2).

6. A control unit (8) configured to carry out the method according to Claim 1.

7. A drive device (1) comprising:
a motor (2);
a power-branched transmission (3) with a variator (5) for the continuously variable adjustment of a gear ratio of the transmission (3); and
a control unit (8) configured to carry out the method according to claim 1.

8. The drive device (1) according to claim 7, further comprising:
a motor control unit (11) configured for receiving the accelerator pedal position (P), wherein the motor control unit (11) is configured to regulate the motor rotation speed of the motor (2) on the basis of the received accelerator pedal position (P) by means of a proportional regulator.

9. The drive device (1) according to claim 8, wherein the motor control unit (11) is further configured to regulate the motor rotation speed of the motor (2) on the basis of a received nominal motor rotation speed (n) and a regulator different from a proportional regulator.

10. A working machine (100) comprising:
a drive device (1) with a motor (2), a power-branched transmission (3) with a variator (5) for the continuously variable adjustment of a gear ratio of the transmission (3), and a control unit (8) configured to carry out the method according to claim 1.
